(19) United States
(12) Patent Application Publication
(10) Pub. No.: US 2011/0122611 A1
(43) Pub. Date: May 26, 2011

(54) SWITCHING CIRCUIT

(76) Inventor: RAINER OPOLKA, Solingen (DE)

(21) Appl. No.: 12/781,906

(22) Filed: May 18, 2010

(30) Foreign Application Priority Data
Nov. 20, 2009 (DE) 102009054119.5

(51) Int. Cl. F21L 4/04

(52) U.S. Cl. 362/205

(57) ABSTRACT

A flashlight switching circuit includes a casing, a power source in the casing having a pair of poles, a light source connected to one of the poles, and a switch carried on the casing. The switch has a housing, first and second contacts with respective inner ends inside the housing and respective outer ends outside the housing and formed as leaf springs, and an actuation element movable on the housing for connecting together the inner ends in a closed position of the switch and disconnecting them from each other in an open position of the switch. The leaf-spring part of the first contact is connected to the light source. The leaf-spring part of the second contact bears directly on the other of the poles so that in the closed position the switch connects the light source between the poles and energizes it.

### FIELD OF THE INVENTION

The present invention relates to a switching circuit. More particularly this invention concerns such a circuit in a flashlight.

### BACKGROUND OF THE INVENTION

A typical lamp or flashlight has a switching circuit comprising a switch, a switch housing, an actuation element and a first and a second contact that both engage in the switch housing.

Such switching circuits are usually used in flashlights, although they can also be used in other switches, such as for example in lamps or other electrical devices. Particularly in the case of flashlights, the switching circuit is often integrated into the end cap screwed onto the rear end of the tubular flashlight casing, the batteries being inserted in the flashlight casing with the end cap unscrewed and the light source and lens being fixed on the front end of the casing. Here, the second contact is connected to a spiral spring that on the one hand holds the batteries inside the flashlight and on the other hand is bears on one pole of the battery, typically a cylindrical one of the AAA to D type, so that the current flows via the spiral spring. In order to establish a closed circuit in the switched-on state, usually the first contact is via the end cap so that electric current flows from there via the screwthread thread or other contact surfaces through the flashlight casing to the load, namely the front-end light source.

One disadvantage of the switching circuits as used in conventional flashlights is first that current passes through several contact interfaces that each present a certain contact resistance. In addition, the current flow in the spiral spring induces a self-induction voltage that counteracts actual current flow. Both of these mean that a lower voltage reaches the light source, as a result of which the light intensity of the light source is considerably reduced.

### OBJECTS OF THE INVENTION

It is therefore an object of the present invention to provide an improved switching circuit.

Another object is the provision of such an improved switching circuit that overcomes the above-given disadvantages, in particular that offers less resistance to the current passing between the power-supply or battery(ies) and the load or light source.

A further object is to eliminate flow through the spiral spring biasing the battery(ies) forward in the casing.

### SUMMARY OF THE INVENTION

In a flashlight, a switching circuit has according to the invention a casing, a power source in the casing having a pair of poles, a light source connected to one of the poles, a switch carried on the casing and including a housing, first and second contacts with respective inner ends inside the housing and respective outer ends outside the housing and formed as leaf springs, and an actuation element movable on the housing for connecting together the inner ends in a closed position of the switch and disconnecting them from each other in an open position of the switch, and means connecting the leaf-spring part of the first contact to the light source. The leaf-spring part of the second contact bearing directly on the other of the poles so that in the closed position the switch connects the light source between the poles and energizes it.

This construction avoids a large number of contact surfaces. In particular, there is no need for a contact between the first contact and the contact spring. In addition, the current no longer passes through the spiral spring so that no power is lost due to the relatively high intrinsic inductance of a spiral spring. In particular, less power is lost in the switching circuit according to the invention so this power is available for the light source.

In particular, according to one preferred embodiment the light source is an LED and a battery is provided as the power source, typically a standard dry cell with positive button at one end and negative pole at the other. Above all, the use of an LED as the light source reduces current consumption so that more energy is available for generating light.

Preferably, the first contact is a bent leaf spring that bears directly on the electrically conductive flashlight casing. In this case, the light source is connected only indirectly to the first contact via the conductive flashlight casing of the flashlight, but nevertheless the switching circuit has at least one less contact since usually the first contact is through the end cap, so that the thread between the end cap and the flashlight casing is used as a contact interface, with the inherent impedance. It is also advantageous in this embodiment that the first contact be always pressed uniformly against the flashlight casing. A reliable contact is thus provided regardless of the position of the end cap in which the switch is mounted. As an alternative to this, the first contact may also be directly connected to the light source, so the end cap and the flashlight casing then cannot be separated from one another and are always held together at least via the first contact.

According to a further preferred embodiment, the actuation element is axially movable and has on the end face an electrically conductive contact plate that can be connected simultaneously to the two contacts. This provides a simple possibility for forming a pushbutton with as few contacts as possible.

As an alternative to this, one contact may be a bent leaf spring that is inside the switch housing and that in the relaxed condition is spaced from the other contact, the two contacts being connectable by the actuation element against the force of the leaf spring. This way, another contact is saved compared to the alternatives using a contact plate. However, in both alternative embodiments, the actuation element is a pushbutton or rotary knob that is axially movable against the force of a spiral spring. As a result, the actuation element in the unloaded state is kept spaced from the contacts, so that any undesired switching on or off of the flashlight is prevented.

Finally, according to another advantageous embodiment of the invention, latching elements are provided on the actuation element so that a keying function or optionally a permanent switching function can be set. This increases not only the ease of handling of the flashlight but also its functionality.

### BRIEF DESCRIPTION OF THE DRAWING

The above and other objects, features, and advantages will become more readily apparent from the following description, reference being made to the accompanying drawing in which:

FIG. 1a shows a switch according to the invention with contacts;

FIG. 1b shows the switch integrated into a flashlight end cap;

FIG. 1c shows a complete switching circuit in accordance with the invention;

FIG. 2 shows one embodiment of the switch according to the invention; and

FIGS. 3a and 3b show another embodiment of the inventive switch in the open and closed positions, respectively.

### SPECIFIC DESCRIPTION

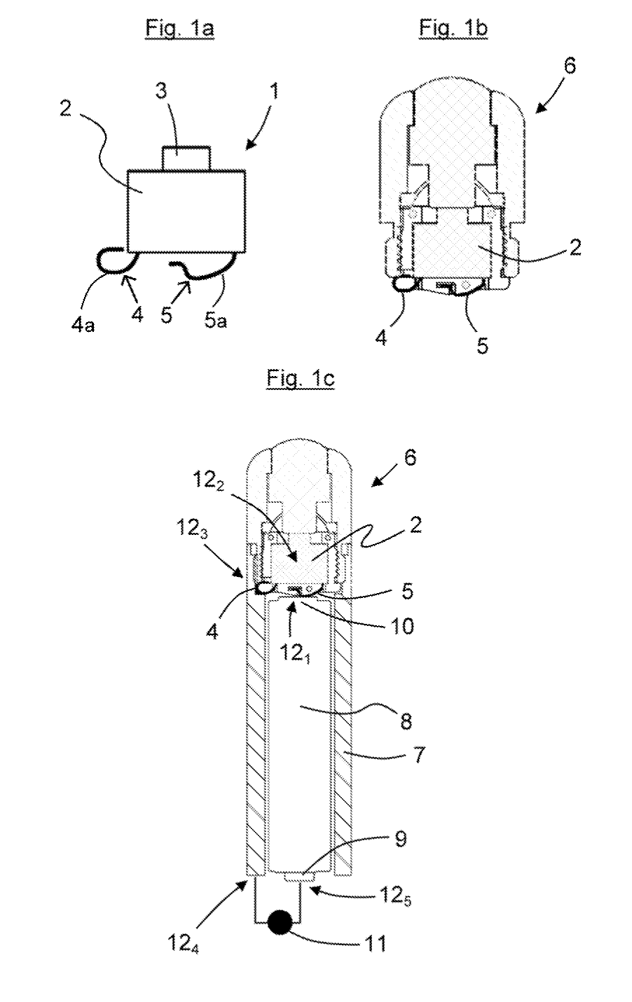

As seen in FIG. 1a, a switch 1 as preferably used in the switching circuit according to the invention comprises a switch housing 2 and an actuation element 3, the latter shiftable along an axis A to close the switch 1. It also has a first contact 4 and a second contact 5, both having outer ends 4a and 5a formed outside the housing 2 as bent leaf springs so as to provide a reliable connection. Such a switch 1 as shown in FIG. 1b is integrated together with the contacts 4 and 5 protruding out of the switch housing 2 into a pushbutton switch 6 that can be screwed onto the end of a flashlight casing 7 as shown in FIG. 1c, forming an end cap thereof. The casing 7 holds a battery 8 having the poles 9 and 10, the latter bearing directly on the leaf-spring outer end 5a of the second contact 5. The first contact 4 on the other hand bears directly with its spring end 4a on the conductive flashlight casing 7.

The switching circuit is thus formed of the battery 8, the switch 2 with the contacts 4 and 5, the flashlight casing 7 and a light source 11 connected between the casing 7 and the other pole 9 of the battery 8. For the case where just one contact is provided within the switch, as shown in FIG. 1c only five contact surfaces 12_{1,2,3,4,5} are formed in the switching circuit shown in FIG. 1c.

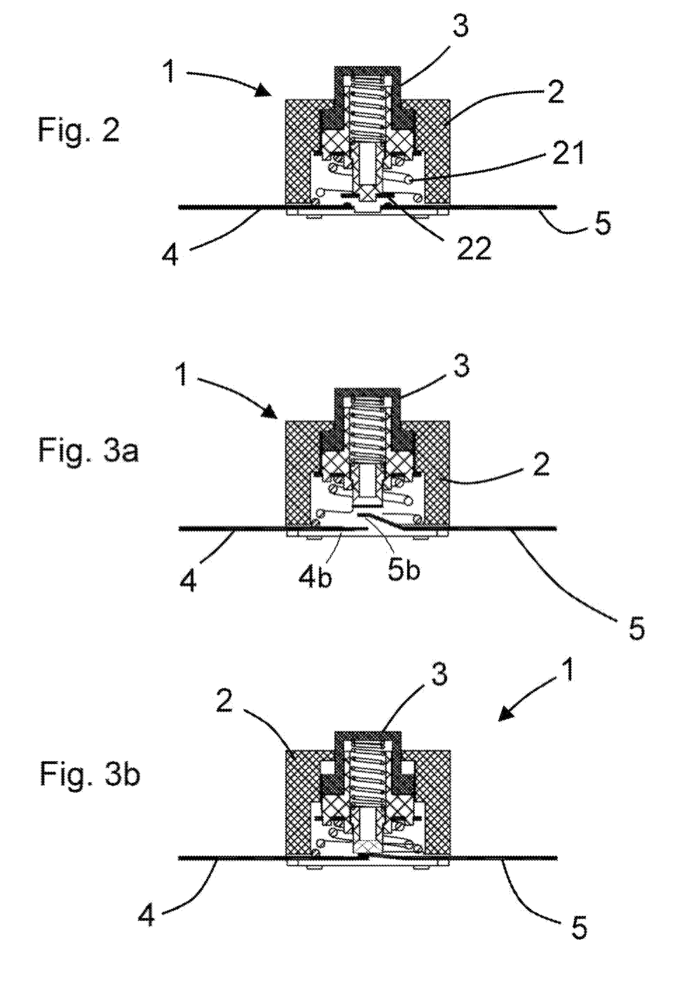

FIG. 2 shows an embodiment of the switch used in the switching circuit according to the invention. The actuation element 3 is mounted in an axially movable manner, biased into in an outer position at a spacing from the contacts 4 and 5 by the force of a spiral spring 21. The actuation element 3 shown in FIG. 2 has an end face carrying a contact plate 22 that, when the actuation element 3 is actuated, is pressed against the inner ends 4b and 5b of the contacts 4 and 5, thereby closing the circuit.

FIGS. 3a and 3b show anther embodiment where the inner end 5b of the second contact 5 is formed inside the switch housing 2 as a leaf spring, and the contacts 4 and 5 can be brought into contact by the actuation element 3 pressing the inner spring end 5b of the contact 5 into engagement with the stationary inner end 4b of the contact 4. FIG. 3a shows the switch 1 in the open position, FIG. 3b in the closed position.

I claim:

1. In a flashlight, a switching circuit comprising:
a casing;
a power source in the casing having a pair of poles;
a light source connected to one of the poles;
a switch carried on the casing and including
a housing,
first and second contacts with respective inner ends inside the housing and respective outer ends outside the housing and formed as leaf springs, and
an actuation element movable on the housing for connecting together the inner ends in a closed position of the switch and disconnecting them from each other in an open position of the switch; and
means connecting the leaf-spring part of the first contact to the light source, the leaf-spring part of the second contact bearing directly on the other of the poles, whereby in the closed position the switch connects the light source between the poles and energizes it.

2. The switching circuit defined in claim 1 wherein the power source is a battery.

3. The switching circuit defined in claim 2 wherein the light source is a light-emitting diode.

4. The switching circuit defined in claim 1 wherein the casing is the means and that the leaf-spring part of the first contact bears directly on the casing.

5. The switching circuit defined in claim 1 wherein the actuation element is a pushbutton movable along an axis.

6. The switching circuit defined in claim 5, wherein the switch further includes
a spring biasing the pushbutton into an outer position.

7. The switching circuit defined in claim 5 wherein the pushbutton has an inner end carrying a conductive plate engageable with the inner ends of both contacts in the closed position.

8. The switching circuit defined in claim 5 wherein the inner end of one of the contacts is engageable with the pushbutton and is formed as a spring elastically deformable by the pushbutton into engagement with the inner end of the other of the contacts.

9. The switching circuit defined in claim 1 wherein the actuation element has latching elements so that a keying function or a permanent switching function can be set
